(19) United States
(12) Patent Application Publication
(10) Pub. No.: US 2013/0214617 A1
(43) Pub. Date: Aug. 22, 2013

(54) POWER MANAGEMENT MONITOR APPARATUS

(71) Applicant: Graham Cleary, Bushland Beach (AU)

(72) Inventor: Graham Cleary, Bushland Beach (AU)

(21) Appl. No.: 13/819,807

(22) PCT Filed: Aug. 31, 2011
(86) PCT No.: PCT/AU2011/001120

§ 371 Date: May 6, 2013

(30) Foreign Application Priority Data
Sep. 1, 2010 (AU) 2010903925

(51) Int. Cl. H01H 35/00

(52) U.S. Cl. CPC H01H 35/00
USPC 307/116

(57) ABSTRACT

Power management monitor apparatus for managing an output power supply from an input power supply including:
electrical isolation means operable for electrically isolating and connecting the output power supply from the input power supply;
control means operatively associated with the electrical isolation means;
sensing means electrically connected to the control means for sensing presence of a person within a space to be monitored as an input to the control means;
perimeter detecting means electrically connected to the control means for detecting breaching of the perimeter of the space to be monitored as another input to the control means;
program means programmed into the control means for programming the isolation of the input power supply from and connection of the input power supply to the output power supply according to the inputs received from the sensing means and the perimeter detecting means.

This invention relates to a power management monitor apparatus. The invention has particular application to a power management monitor apparatus for managing power supply to a room air conditioner by monitoring access into, egress from and movement within a room or building. However, the power management monitor apparatus according to the present invention may have application in other areas where power consumption may be minimised in buildings or spaces when they are unoccupied.

Accommodation provided for personnel, for example, mining personnel, may be provided in the form of individual apartments as stand-alone buildings or attached to common areas such as lounge room and/or dining areas. In the mining industry in particular, the climate can be hotter or colder than normal temperate comfort levels, with the result that cooling or heating is required. However, such apartments may be unoccupied for various times when the occupant or tenant is on shift or is otherwise absent from the accommodation. The occupant may not always remember to switch the power off, particularly in the case of heaters or air conditioners which are both high power users. Timers have been provided to address this problem, but do not accommodate variable occupation times.

The present invention aims to provide a power management monitor apparatus which alleviates one or more problems of excessive power consumption. Other aims and advantages of the invention may become apparent from the following description.

With the foregoing in view, in one aspect the present invention resides broadly in a power management monitor apparatus for managing an output power supply from an input power supply including:

electrical isolation means operable for electrically isolating and connecting the output power supply from the input power supply;

control means operatively associated with the electrical isolation means;

sensing means electrically connected to the control means for sensing presence of a person within a space to be monitored as an input to the control means;

perimeter detecting means electrically connected to the control means for detecting breaching of the perimeter of the space to be monitored as another input to the control mean;

program means programmed into the control means for programming the isolation of the input power supply from and connection of the input power supply to the output power supply according to the inputs received from the sensing means and the perimeter detecting means.

Preferably, program means includes timers and such like to permit the input and output power supplies to remain connected or isolated for a period of time after an input has been received from the sensing means and the perimeter detection means. In a preferred form, the sensing means is motion sensor. It is also preferred that the controller includes indication means for indicating the status of the input and output power supplies.

It will be appreciated that the controller may control more than one input power supply or more than one output supply. Suitably, the controller is itself powered from one of the input power supplies and subject to conversion to a suitable power supply for the controller to provide a controller power supply. In a preferred form, the electrical isolation means is provided as a power isolation relay operated between an open state and a closed state by the controller. The input power supply is electrically connect to one side of the power isolation relay and the output power supply is electrically connected to the other side of the power isolation relay. In the open state, the input and output power supplies are isolated from one another. Conversely, in the closed state, the input and output power supplies are connected to one another.

In a preferred form, there are two power isolation relays, two input power supplies and two output power supplies, each input power supply being electrically connectable to one of the output power supplies by one of the power isolation relays. As the typical power supply is an alternating current power supply having an active conductor, a neutral conductor and an earth conductor, it is preferred that the power isolation relays switch on the active conductor only, the neutral and earth conductors being connected through or bypassing the power isolation relay.

The controller is provided with a controller power supply such as a six volt, direct current power supply suitable for supplying power required to electronic components. The program for the controller is provided in a programmable integrated circuit chip, and other electronic components, such as resistors, capacitors, light emitting diodes and such like are connected to provide the functionality herein described for the power management monitor apparatus of the invention.

In order that the invention may be more readily understood and put into practical effect, reference will now be made to the following drawings which illustrate a preferred embodiment of the invention, and in which:

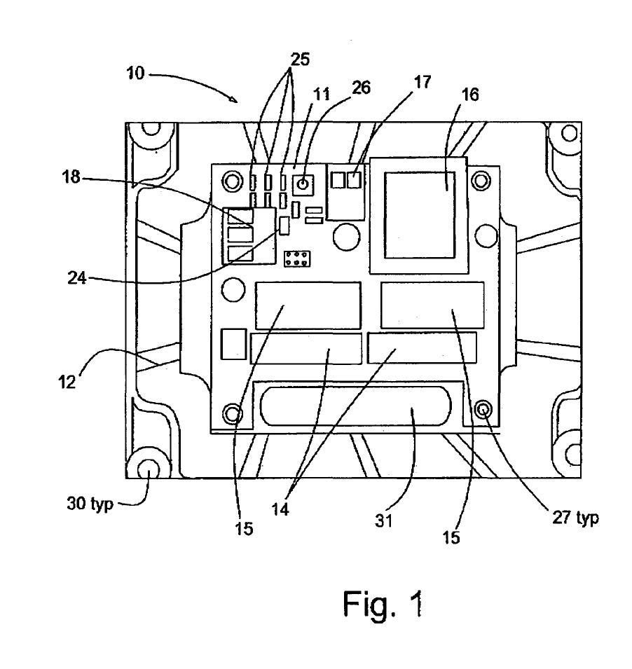

FIG. 1 is a photograph showing a circuit board and components inside an electrical box for the power management monitor apparatus according to the invention; and

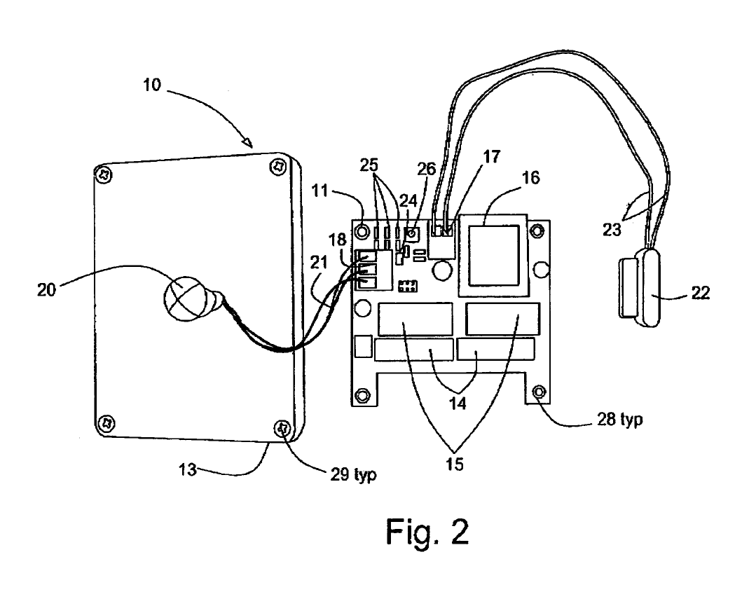

FIG. 2 is a photograph showing the circuit board and components with some further components to further illustrate the power management monitor apparatus of FIG. 1.

The power management monitor apparatus 10 illustrated in FIGS. 1 and 2 together include all of the components thereof. However, some components have been removed from each of the photographs in order to show of the features more effectively. The reference numerals are not necessarily included in each photograph to aid in clarity of illustration, but it will be appreciated that there components common to both photographs.

The power management monitor apparatus includes a circuit board 11 fixed into an electrical box 12 having a lid 13. The circuit board has two power supply terminal blocks 14, each having six terminals for connecting various conductors. In each case, the power supply terminal blocks have terminals for connecting an active, a neutral and an earth conductor from an input power supply and an active, a neutral and an earth conductor to an output power supply. However, the neutral and earth conductors for the input and output power supplies are connected directly to one another (by way of the terminal block), the active conductors only being switched, that is, isolated and reconnected, according to the program of the apparatus.

The switching of the active conductors is provided by two relays 15, one associated with each power supply terminal block. A transformer 16 is also powered by one of the input power supplies (the one on the right of the photographs of FIGS. 1 and 2) in order to provide a suitable power supply to the components of the electronic circuit mounted to circuit board. The relays are normally open relays (or changeover relays wired as normally open relays) for at least one of switched pair of terminals of the relays.

The circuitry and components of and mounted to the circuit board include a reed switch terminal 17 and a motion sensor terminal 18. As shown in FIG. 2 in particular, a motion sensor 20 is electrically connected to the motion sensor terminal via three motion sensor conductors 21 and a reed switch 22 is electrically connected to the reed switch terminal by a pair of reed switch conductors 23.

An integrated circuit chip 24 is mounted to the circuit board to the right of the motion sensor terminal and is programmed with a program as detailed herein. The circuit also includes three light emitting diodes 25 mounted to the top left of the circuit board and are operable to display the status of the circuit. The light emitting diodes are designated L1, L2 and L3 from left to right in the orientation of the circuit board as shown.

An override switch 26 is mounted between the light emitting diodes and the reed switch terminal block for bypassing the programmed switching of the circuit to toggle the output power supply between a connected state and a programmed switched state, being connected, isolated or reconnected as the case may be according to the program. Resistors, capacitors, jumper switches, transistors and such like are also provided to complete the circuit.

The circuit board is mounted to the base of the electrical box by four circuit mounting screws shown typically at 27 as shown in FIG. 1 which each of which pass through one of four screw holes shown typically at 28 in the corners of the circuit board as shown in FIG. 2. The lid may be secured to the electrical box by four closure screws shown typically at 29 in FIG. 2 each being inserted and tightened into one of four threaded blind screw holes shown typically at 30 in FIG. 1. The power supply conductors (not shown), suitably insulated, pass into the electrical box through an obround aperture 31 adjacent the power supply terminal blocks of the circuit board when mounted to the electrical box as shown in FIG. 1.

The power management monitor apparatus according to the present invention is powered via the mains line within the space to be monitored, such as a room, unit or complex which will be input via MAINS IN (230V, 50 Hz, 12 A, which is also replicated at the MAINS out), which then will proceed to the transformer, being in the example shown, on board short circuit proof safety isolating transformer at an input of 230V, 50-60 Hz and a no load Loss of 1.0 W.

The transformer will then regulate the voltage down to 6V to be able to power the components on the circuit. This will create a power of 1.5VA. The current travelling through the PCB board is then controlled by on board components (resistors, capacitors and transistors).

The reed switch is mounted adjacent its switching magnet (not shown) at a typical location on the door. In the example illustrated, the reed switch is a 5Vdc (5 mA) Door Reed Switch which is connected to the circuit board by the reed switch terminal block and is connected to the door via a hardwire 240V cabling so there is no interference with other cabling within the unit. This cable is connected to an always closed circuit switch, which when the door is opened breaks the circuit, which in turns activates the controller.

When the reed switch is activated a signal is sent to the circuitry which activates the infrared motion sensor. This sensor will then scan the room for a period of 30 seconds for any movement from within the room. If movement is detected it will send a signal to the relay, which is a 1 pole 16 A, 1 changeover (CO) or normally open (NO) contact relay. This relay has reinforced insulation with an ambient temperature of 105° C.

The relay will then turn on the lighting and air conditioning from within the room. When the door is opened and the infrared sensor detects no movement inside the room within 30 seconds it is then deemed that there is no one inside the room and will commence a one hour shut down of the devices unless someone enters within the one hour shutdown process. If the door is left open at any point the apparatus will shut down all devices attached (air con, lights) after a designated one minute or ten minutes.

These one or ten minutes is decided by a jumper which is located on the circuit board. This unit will obtain the power from the IC chip 1 where the Neutral and Earth terminals are connected back around inside the unit which will also provide the neutral and earth fox the relay and the transformer. The active line is switched by two 16 amp 240Vac relay components. During the operation there are LEDs on the PCB board to signify the operation of the unit, which will assist in diagnostics of the device. These are L3 (using resister R7) which indicates the power of the device, L2 (using resister R6) which flashes upon power up for 30 seconds (at a one second rate) during initialisation and then the unit will go into normal operation and flashes when movement is detected by the infrared Sensor, and L1 (using resister R9) which lights up in normal mode if power is switched through to the load.

On the circuit board (PCB) there is also an override bypass switch at 26. The override switch enables connection of power to lights or air conditioning permanently. A second push of the override switch will return it back to the monitoring mode and normal operation. This will continue to toggle between these two modes when the switch is pressed.

The circuit is protected for surge via a 0.5 A PCB fuse which protects all the devices mounted on the PCB. The peak surge rating of this device is rated at Mains in and out 240V, 50 Hz at 15 A for 5 seconds. The circuit also contains a continuous rating of 12 A 240Vac.

The control logic within this device is all located via a small on board microprocessor which is pre programmed for the correct operation of the device. The processor within the main IC chip has an activation code pre programmed into it and an activation code which will prevent piracy and unauthorised access to the chip so it will remain in operation as intended.

Although the invention has been described with reference to a specific example, it will be appreciated by persons skilled in the art that the invention may be embodied in other forms within the broad scope and ambit of the invention as herein set forth and defined by the following claim.

1. A power management monitor apparatus for managing an output power supply from an input power supply including:
electrical isolation means operable for electrically isolating and connecting the output power supply from the input power supply;
control means operatively associated with the electrical isolation means;
sensing means electrically connected to the control means for sensing presence of a person within a space to be monitored as an input to the control means;
perimeter detecting means electrically connected to the control means for detecting breaching of the perimeter of the space to be monitored as another input to the control means;
program means programmed into the control means for isolating the input power supply from the output power supply when the perimeter detecting means is activated and the sensing means receives no input, and for connecting the input power supply to the output power supply when the perimeter detecting means is activated and the sensing means receives an input.

2. The power management monitor apparatus according to claim 1, wherein the program means includes timers to permit the input and output power supplies to remain connected or isolated for a period of time after an input has been received from the sensing means and the perimeter detection means.

3. The power management monitor apparatus according to claim 1, wherein the sensing means comprises a motion sensor.

4. The power management monitor apparatus according to claim 1, wherein the controller includes indication means for indicating the status of the input and output power supplies.

5. The power management monitor apparatus according to claim 1, wherein the controller controls one or more input power supplies and/or one or more output supplies.

6. The power management monitor apparatus according to claim 5, wherein the controller is powered from one of the input power supplies and subject to conversion to a suitable power supply for the controller to provide a controller power supply.

7. The power management monitor apparatus according to claim 6, wherein the electrical isolation means is provided as a power isolation relay operated between an open state and a closed state by the controller, the input power supply being electrically connected to one side of the power isolation relay and the output power supply being electrically connected to the other side of the power isolation relay, whereby, in the open state, the input and output power supplies are isolated from one another and, conversely, in the closed state, the input and output power supplies are connected to one another.

8. The power management monitor apparatus according to claim 7, wherein two power isolation relays, two input power supplies and two output power supplies are provided, each input power supply being electrically connectable to one of the output power supplies by one of the power isolation relays.

9. The power management monitor apparatus according to claim 8, wherein the controller is provided with a controller power supply suitable for supplying power required to electronic components, the program for the controller being provided in a programmable integrated circuit chip, and other electronic components being connected to provide functionality.
